(19) United States
(12) Patent Application Publication
(10) Pub. No.: US 2004/0118010 A1
(43) Pub. Date: Jun. 24, 2004

(54) Clothes dryer

(76) Inventor: Andrew Michael Shardlow, Wales (GB)

Correspondence Address: Barry E. Bretschneider, Morrison & Foerster, Suite 300, 1650 Tysons Boulevard, McLean, VA, 22102, US

(21) Appl. No.: 10/475,672

(22) PCT Filed: Apr. 23, 2002
(86) PCT No.: PCT/GB02/01890

(30) Foreign Application Priority Data
Apr. 24, 2001 (GB) 0110130.0
May 31, 2001 (GB) 0113163.0

(51) Int. Cl. F26B 11/02

(52) U.S. Cl. 34/595

(57) ABSTRACT

A clothes dryer comprises a main chamber (C1) for receiving clothes to be dried, an evacuating pump (P1) coupled between the main chamber (C1) and a secondary chamber (C2) provided with an evacuating pump (P2): the first pump (P1) is of a large flow-rate compared with the second pump (P2). Superheated cool steam may be injected into the main chamber (C1), serving both to heat and dry the wet clothes: the superheated cool steam may be generated in a water-containing vessel (30) in which a heat exchanger tube (12), coupled between the two chambers (C1, C2), is disposed.

The present invention relates to a clothes dryer which relies upon evacuation of the chamber containing the clothes.

Clothes dryers have been proposed hitherto which rely upon evacuation of the vessel or chamber which contains the clothes in order to reduce the pressure to below the saturated vapour pressure of water at ambient temperatures: under this condition, the water within the chamber boils and the water vapour is extracted by the evacuating pump. Such clothes dryers have, however, not proved to be practical.

I have now devised a clothes dryer, which relies upon evacuation of the chamber containing the clothes to be dried, and which theoretically should work effectively.

In accordance with the present invention, there is provided a clothes dryer which comprises a main chamber for receiving clothes to be dried, a secondary chamber, a first evacuating pump coupled between the main chamber and the secondary chamber, and a second evacuating pump coupled to an outlet of the secondary chamber, the first pump being of large flow-rate as compared with the second pump.

The following analysis will explain the requirement for the first pump to be of large flow-rate as compared with the second pump.

In order for the dryer to dry the clothes quickly, it is necessary for the water within the clothes to boil, so that the evaporation is not restricted to their surfaces. In order to achieve this, it is necessary to reduce the partial pressure of the air within the main chamber to approach zero, such that the overall pressure approaches the saturated vapour pressure of water.

Consider a sealed vessel containing a mixture of a gas and a vapour, the vapour being in equilibrium with its liquid phase. The pressure of this mixture can be reduced by pumping. If we make the simplifying assumption that the vapour pressure remains constant (i.e. there is no temperature change) as the liquid evaporates to maintain equilibrium, then the effect of the pumping is purely to reduce the partial pressure of the gas within the vessel. With a constant flow-rate through the pump, the partial pressure of the gas will reduce exponentially at a rate identical to that which would occur if no vapour were present. Thus, the problem of reducing the pressure towards saturated vapour pressure corresponds, more or less, to the problem of reducing the pressure in a gas-filled vessel towards zero.

Consider now an arrangement consisting of a first pump P1 coupled between a main chamber C1 and a secondary chamber C2, and a second pump P2 coupling the secondary chamber to atmosphere. If we assume a small, constant leak of gas into chamber C1 under steady state conditions, then if the partial pressures pp1, pp2 of the gas in chambers C1 and C2 are to be constant (and therefore the respective total pressures in chambers C1 and C2 are to be constant), the flow rates Q1 and Q2 through the pumps P1, P2 must obey the relationship:

pp1.Q1=pp2.Q2

In the dryer of the present invention, the partial pressure pp1 of air in the main chamber is very low compared with the partial pressure pp2 of air in the secondary chamber: therefore, the flow-rate Q1 of the first pump is required to be high as compared with the flow-rate Q2 of the second pump. This high flow-rate of the first pump is advantageous, in that the water vapour, being carried by the air being evacuated, is removed rapidly and, to maintain saturated vapour pressure, water will condense in the secondary chamber (or in the duct leading from the first pump to the secondary chamber).

In practice, a heat exchanger tube is coupled between the outlet of the first pump and the inlet of the secondary chamber, in heat-exchange association with the main chamber of the dryer. Thus, water vapour condenses in the heat exchanger tube and the corresponding latent heat of evaporation is returned to the main chamber to counter the latent heat of evaporation which is extracted as the water boils within the main chamber. The heat exchanger tube may be positioned within the main chamber or in direct contact with the outside of the main chamber or (as will be explained later in this specification) transfer heat to an intermediate medium.

Advantageously, means may be provided to purge the main chamber of its air, before or soon after the evacuation process commences. For example, the dryer may be arranged to pass cool steam through the main chamber during an early phase of the evacuation process. By “cool steam” is meant steam at a temperature lower than the boiling point of water at standard pressure, and typically generated by boiling water under reduced pressure, conditions. As another example, the main chamber may be provided with a membrane which deforms to embrace closely around the load (i.e. the body of wet clothes) upon commencement of the evacuation process: once the membrane has deformed to embrace the load in this manner, very little air remains to be evacuated. Preferably the membrane is provided by a balloon disposed within the main chamber, the balloon being arranged to expand to fill the remaining space within the main chamber, upon commencement of evacuation thereof, and such that a portion of the balloon embraces the body of wet clothes. Minimal air is then left within the main chamber, requiring evacuation.

The dryer of the present invention may be arranged to inject superheated cool steam into the main chamber, serving to both heat and dry the wet clothes. Thus, the tendency of the drying clothes is to cool, such that it is necessary to supply heat to it, and the superheated cool steam serves this purpose: this vapour transfers heat to the clothing without wetting it, but ultimately condenses within the system.

It will be surprising, and counter-intuitive, that water vapour can perform this role, but can be explained as follows. Consider a steam generator producing steam at 1 atm pressure and therefore at a temperature of 100° C.: this steam can then be heated to increase its temperature to a selected value, say 120° C. Suppose this superheated steam is bubbled through water in a container: initially, condensation would occur, and the water in the container heated up; as the temperature of the water reaches 100° C.; and superheated steam continues to be bubbled through it, the water would boil and so dry off.

The use of superheated cool steam, in the dryer of the present invention, has a corresponding effect, the chamber containing the clothes being partially evacuated such that the water in the clothes boils at a correspondingly reduced temperature (typically below 50° C.).

For producing the superheated cool steam, preferably the outlet of the first pump is coupled to the inlet of the secondary chamber by means of a heat exchanger tube disposed in a vessel containing water, the space of this vessel above the water communicating with the interior of the main chamber. In use of the dryer, heat is transferred to the water in this vessel as the vapour extracted from the main chamber condenses within the heat exchanger tube: the space above the water is under reduced pressure such that the water boils; the steam thus produced is heated as it passes towards the main chamber, into which it is injected.

In each of the above-described embodiments, the-second pump may exhaust directly to atmosphere: instead, it may couple to a further chamber, from which a third pump exhausts to atmosphere; in general, there may be N chambers (N≧2) in series, with successive chambers coupled by respective pumps and the final chamber coupled by a final pump to atmosphere. In these arrangements, each pump has a higher flow-rate than the next pump in the series. The first chamber is the largest and is arranged to receive a load of wet clothes, whilst the subsequent chamber or chambers are smaller and act as condensation chambers. The bulk of the condensate collects in the first condensation chamber, whilst a substantially smaller amount of condensate collects in the or each subsequent condensation chamber: thus, because the saturated vapour pressure is constant in all condensation chambers (assuming constant temperatures), the condensation rate in each chamber is proportional to its inlet pump flowrate minus its outlet pump flow-rate. It is preferable for each pump to have a smaller pressure difference (between its inlet and outlet) as compared with the next pump of the series.

The feature of injected superheated cool steam may be used more generally in clothes dryers. Thus, also in accordance with the present invention, there is provided a clothes dryer which comprises a chamber for receiving clothes to be dried, an evacuating pump having its inlet coupled to said chamber, and means for generating superheated cool steam and for introducing said superheated cool steam into said chamber.

Embodiments of the present invention will now be described by way of examples only and with reference to the accompanying drawings, in which:

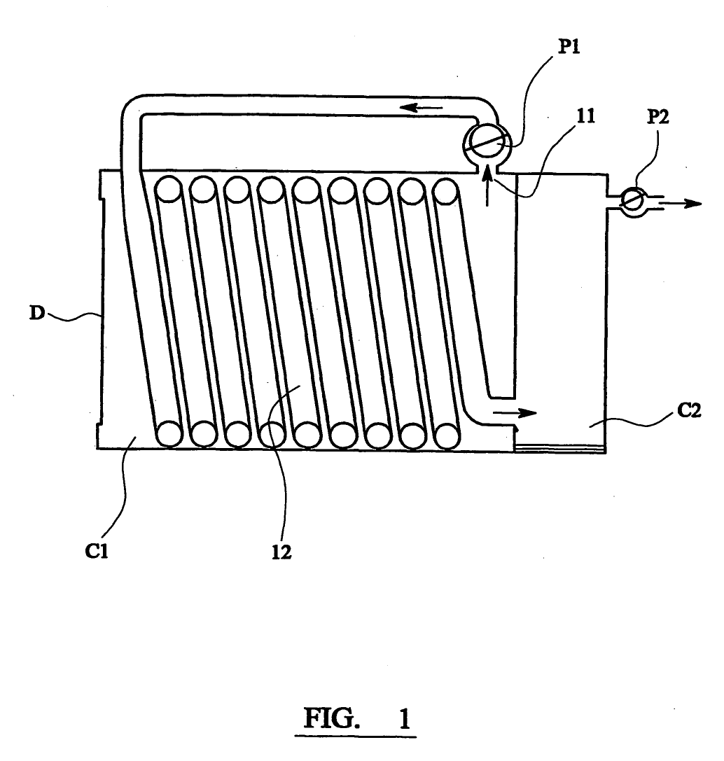

FIG. 1 is a diagrammatic view of a first embodiment of clothes dryer in accordance with the invention;

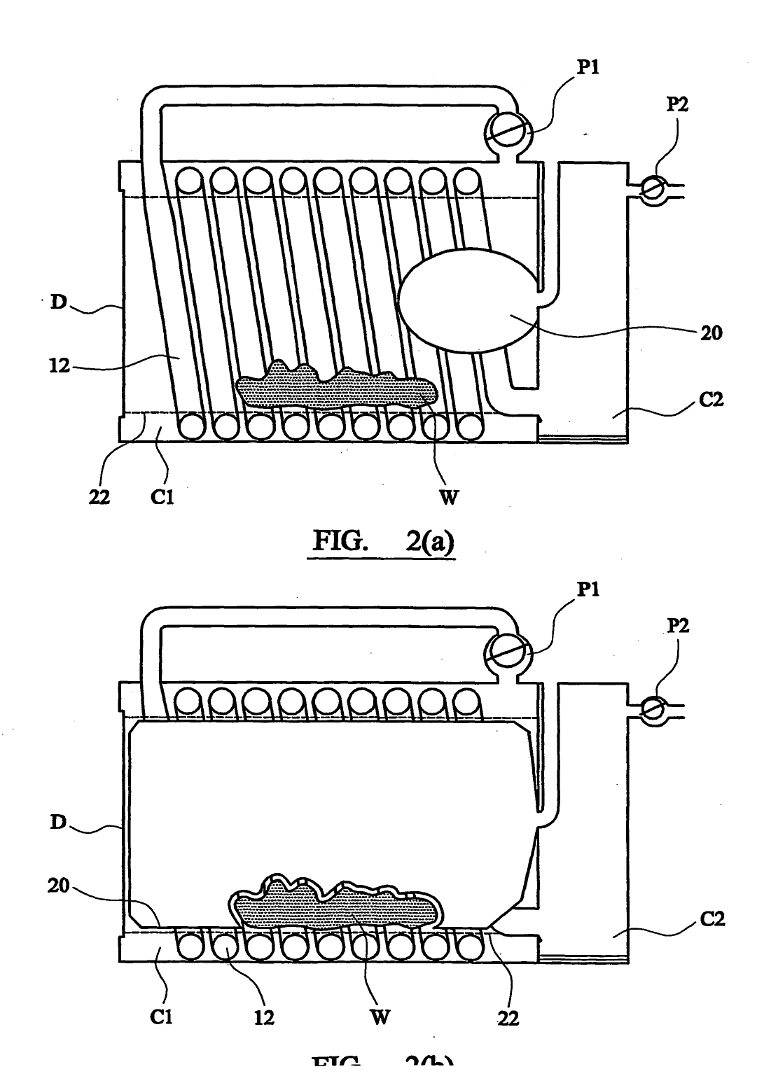

FIG. 2 consists of two diagrammatic views of a second embodiment of clothes dryer in accordance with the invention, the dryer being shown at successive stages during a cycle of operation; and

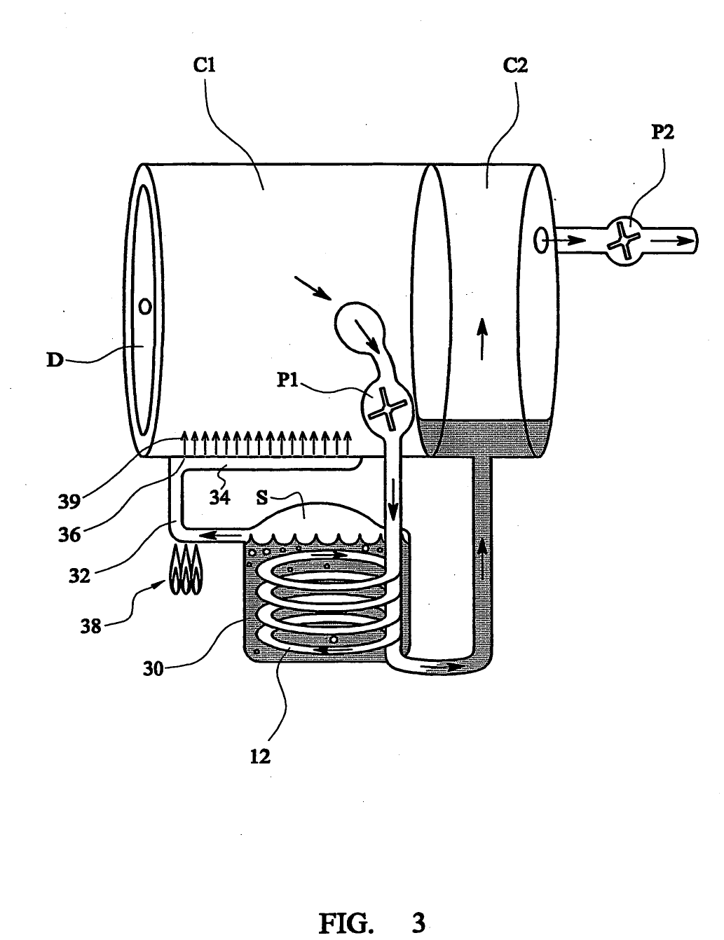

FIG. 3 is a diagrammatic view of a third embodiment of clothes dryer in accordance with the invention.

Referring to FIG. 1, there is shown a clothes dryer which comprises a main chamber C1 for receiving clothes to be dried, and a secondary chamber C2: a heat exchanger tube 12 is coiled around the main chamber C1 (either internally or externally,of the chamber); a first pump P1 has its inlet coupled to an outlet 11 of the main chamber C1 and its outlet coupled to one end of the heat exchanger tube 12, whilst the opposite end of the heat exchanger tube 12 is coupled to an inlet to the secondary chamber C2. A second pump P2 couples an outlet of the secondary chamber C2 to atmosphere.

The first pump P1 is of relatively large flow-rate compared with the second pump P2 for the reasons explained above. Further, the first pump P1 provides a relatively small pressure-difference between its inlet and outlet sides, as compared with the second pump P2.

The main chamber C1 is formed with an opening for putting clothes in and taking clothes out, and a door D is provided for closing this opening in hermetically sealed manner.

In use of the dryer, the wet clothes are placed in the main chamber C1 and the door is closed: then the pumps P1 and P2 are energised in order to pump out the air and water vapour from the main chamber C1. When the pressure within the main chamber C1 becomes lower than the saturated vapour pressure of water at room temperature, the water within the main chamber C1 boils: the latent heat of evaporation of the water will tend to cool the main chamber and its contents. However, the exhaust stream being pumped through the heat exchanger tube 12 comprises a very high proportion of water vapour with a partial pressure well in excess of saturated vapour pressure, such that much of this water vapour condenses: the condensation occurs in the heat exchanger tube 12, therefore in contact with the main chamber C1, and counters the cooling tendency of the contents of chamber C1 by giving up latent heat of evaporation. The condensed water passes to the secondary chamber C2.

Preferably the dryer is arranged to generate a supply of cool steam and pass this through the main chamber C1 (in order to purge this chamber of its air) during an early phase of the evacuation process. This cool steam is produced by boiling water in a reduced-pressure vessel (not shown): preferably the cool steam is produced at a temperature of 40-50° C.

FIG. 2 of the drawings shows a second embodiment of dryer, which takes an alternative approach for purging the air from the main chamber during an early phase of the evacuation process. Thus, the main chamber C1 is provided with a balloon 20 having its interior coupled to atmosphere. In use, the door D to the main chamber C1 is opened and the clothes introduced into this chamber (FIG. 2a). When the evacuation pumps P1 and P2 are energised to start evacuating the main chamber C1, the balloon 20 expands to fill the remaining space within the main chamber C1, a portion of the balloon embracing closely around the body W of wet clothes (FIG. 2b). Under this condition, a minimal volume of air is left within the chamber C1. The chamber C1 includes a perforated or permeable inner shell 22, on which the body W of wet clothes rest, and through which the residual air and the water vapour are withdrawn by the pumps P1 and P2.

Referring now to FIG. 3 of the drawings, there is shown a third embodiment of clothes dryer in accordance with the invention: in this embodiment, superheated cool steam flows into the main chamber C1 and serves to both heat and dry the body of clothes within this chamber. As in the embodiment of FIG. 1, the dryer comprises a main chamber C1 to receive the clothes to be dried, and a secondary chamber C1. A first pump P1 has its inlet coupled to an outlet of the main chamber C1 and its outlet coupled to one end of a coiled heat exchanger tube 12: the opposite end of the heat exchanger tube 12 is coupled to an inlet to the secondary chamber C2. A second pump P2 couples an outlet of the secondary chamber C2 to atmosphere. Also as in the dryer of FIG. 1, the main chamber C1 has an opening for putting clothes in and taking clothes out of the dryer, and a door D serves to close this opening in hermetically sealed manner: further, the first pump P1 is of relatively large flow-rate compared with the second pump P2, for the reasons previously explained, and the first pump P1 provides relatively small pressure-difference as compared with the second pump P2.

It will be noted that the coiled heat exchanger tube 12 is disposed within a vessel or reservoir 30 containing water: the upper region S of the vessel 30, above the water level, is coupled by a duct 32 to a manifold 34 on the wall of the main chamber C1, the manifold 34 communicating with the interior of the chamber C1 via an array of small orifices 36. A heating means 38 provides a small amount of heat to the cool steam passing along the duct 32.

In use of the dryer shown in FIG. 3, then similar to the dryer of FIG. 1, water vapour condenses in the heat exchanger tube 12 and the condensed water passes into the secondary chamber C2: in condensing, the water vapour gives up latent heat of evaporation, which is absorbed by the water in the vessel 30; the space at the top of the vessel 30 is under a reduced pressure (being in communication with the main chamber C1 via the duct 32), such that the water in the vessel 30 boils, providing a stream of cool steam. This cool steam is superheated by the heating means 38 and the resulting superheated cool steam is injected as jets 39 into the main chamber C1 via the orifices 36.

Typically, and by way of example only, the interior of the main chamber C1 might be at a temperature of 21° C. and the water vapour therein at a pressure of 18 mm Hg, the stream within the heat exchanger tube 12 might be at a temperature of 60° C. and a pressure of 150 mm Hg, the water in the vessel 30 might be at a temperature of 40° C. and the saturated vapour pressure in its top space at 54 mm Hg, and the superheated cool steam injected into the main chamber at 40° C.

It will be appreciated that the superheated cool steam injected into the main chamber C1 serves to both dry and heat the body of clothes within that chamber. Thus, the steam is at a temperature which exceeds the boiling point of its liquid phase, thought this boiling point is reduced by pressure reduction: such steam, upon contact with wet articles which are at the boiling point of water at a reduced pressure, transfer energy to those articles and produce a net evaporation of water in a continuous process and without heat damage.

1) A clothes dryer which comprises a main chamber for receiving cloths to be dried, a secondary chamber, a first evacuating pump coupled between the main chamber and the secondary chamber, and a second evacuating pump coupled to an outlet of the secondary chamber, the first pump being of large flow-rate as compared with the second pump.

2) A clothes dryer as claimed in claim 1, in which a heat exchanger tube, coupled between the outlet of said first pump and the outlet of said secondary chamber, is disposed within said main chamber or in direct contact with the outside of said main chamber.

3) A clothes dryer as claimed in claim 1 or 2, comprising means for purging said main chamber of its air, before or once evacuation of said main chamber commences.

4) A clothes dryer as claimed in claim 3, in which said purging means comprises means for passing cool steam through said main chamber.

5) A clothes dryer as claimed in claim 3, comprising a membrane arranged to deform and embrace closely around the body of clothes within said main chamber, upon commencement of the evacuation thereof.

6) A clothes dryer as claimed in claim 5, in which said membrane is provided by a balloon disposed which said main chamber and arranged to expand to fill the remaining space within said main chamber, upon commencement of the evacuation thereof.

7) A clothes dryer as claimed in claim 1 or 2, comprising means for generating and injecting superheated cool steam into said main chamber.

8) A clothes dryer as claimed in claim 7, in which said means for generating and injecting superheated cool steam into said main chamber comprises a vessel containing water, the space in said vessel above the water communicating with the interior of said main chamber and a heat exchanger tube, which is coupled between the outlet of said first pump and the outlet of said secondary chamber, being disposed within said vessel.

9) A clothes dryer as claimed in any preceding claim, in which said main and secondary chambers form the first and second chambers of a series of chambers coupled by successive evacuating pumps.

10) A clothes dryer which comprises a chamber for receiving clothes to be dried, an evacuating pump having it inlet coupled to said chamber, and means for generating superheated cool steam and introducing said superheated cool steam into said chamber.

11) A clothes dryer as claimed in claim 10, in which said means for generating superheated cool steam comprises a vessel containing water, the space in said vessel above the water communicating with the interior of said main chamber and a heat exchanger tube, which is coupled to the outlet of said evacuating pump, being disposed within said vessel.
